(19) United States
(12) Patent Application Publication
(10) Pub. No.: US 2003/0014395 A1
(43) Pub. Date: Jan. 16, 2003

(54) Communication triggered just in time information

(75) Inventors: Joann Ruvolo, San Jose, CA (US); James H. Kaufman, San Jose, CA (US)

Correspondence Address: LACASSE & ASSOCIATES, LLC, 1725 DUKE STREET, SUITE 650, ALEXANDRIA, VA, 22314, US

(73) Assignee: INTERNATIONAL BUSINESS MACHINES CORPORATION

(21) Appl. No.: 09/902,729

(22) Filed: Jul. 12, 2001

(51) Int. Cl. G06F 7/00

(52) U.S. Cl. 707/3

(57) ABSTRACT

An automatic display is triggered upon the receipt of a communication (e.g., telephone, email, pager, etc.) to present a recipient with relevant information about the originator including background data as well as issues to be addressed or remembered. A Personal Information Management (PIM) system stores the information that associates individuals with a set of data that includes tasks, events, and journal entries. The arrival of a communication triggers a query of the PIM system using the originator's identifier and the corresponding data is retrieved for display.

### BACKGROUND OF THE INVENTION

1. Field of Invention

The present invention relates generally to the field of personal information management (PIM) systems. More specifically, the present invention is related to a system and method for communication-triggered automatic retrieval of information related to a caller/sender of the communication.

2. Discussion of Prior Art

The definitions provided below help assist in the understanding of terminology used throughout the specification. It should, however, be noted that definitions have been provided to help with general understanding of personal information management systems and are not meant to limit their interpretation thereof. Furthermore, other definitions and equivalents may be substituted therefore without departing from the scope of the present invention.

Primary user—The main user of a personal information management system implementing the present invention. It is assumed that the primary user owns and has control over the data stored in the database.

Client—An entity of interest to the primary user. The client is associated with events, to-do lists, journal entries or a profile log maintained by the primary user.

iCalendar standard—Internet Calendaring and Scheduling Core Object specification, published by the Internet Engineering Task Force (IETF), is a rich data format definition for common scheduling objects such as events, to-dos, and journal entries.

Event database—In the iCalendar standard, an event is defined as a group of properties associated with an event calendar component. The event database contains records, one for each event in the system. It represents a scheduled amount of time on a calendar.

To-do database—In the iCalendar standard, a to-do is defined as a group of properties associated with a to-do calendar component. The to-do database contains records, one for each to do in the system. It represents an action item or assignment.

Journal database—In the iCalendar standard, a journal is defined as a group of properties associated with a journal component. The Journal database contains records, one for each journal entry in the database.

Profile database—Contains records for each client of the PIM system of the present invention. Each profile record contains more detailed information about a client, such as the client's background, education, interests, and expertise.

Java™ Message Queue (JMQ)—Message-Oriented-Middleware that provides a common reliable way for programs to create, send, receive, and read messages in any distributed environment.

Remote Procedure Call (RPC)—a type of protocol that allows a program on one computer to execute a program on a server computer.

Remote Method Invocation (RMI)—a set of protocols that enables Java objects to communicate remotely with other Java objects.

Personal Information Management (PIM) systems are tools used to store information such as addresses, scheduled events, important dates, things to be done or other valuable data. PIM systems provide users with an efficient means for organizing their private and business activities.

One useful capability of PIM systems is the ability of a user to associate other individuals with specific entries in the database. The primary user of the PIM system records tasks, scheduled events, to-do lists, observations, and individual profiles. Additionally, clients are related to these entries in the database. For example, in a business environment, client profiles and comment/notes associated with clients are stored in a PIM database and are accessed prior to, or during, a business contact for efficient management of customer relations.

The retrieval of information in PIM systems is generally initiated by performing a manual query of the system. For example, before starting a communication with a client, the primary user searches the PIM systems using a computer program to be reminded of discussion topics or notes taken during a previous call. Data retrieval is also initiated using internal predetermined events such as a time trigger that are programmed by a primary user. For example, a primary user might need to be reminded of an upcoming event some time prior to the event.

The following references describe PIM systems where the client information retrieval is initiated by the primary user of the system or by a predetermined time trigger.

The U.S. Pat. No. 5,842,009 describes a method for automatically providing a user with documents and information relevant to a scheduled event at a predetermined time prior to the event.

The U.S. Pat. No. 5,737,726 describes an information management system where customer contact information is stored and retrieved when needed. Prior contacts can be searched and located by generating filter criteria through the order-independent selection of contact types, contact sub-types, customer identification, and customer contact types.

The U.S. Pat. No. 4,819,191 describes a method for triggering the display of data at a scheduled time using an interactive calendar. Additionally, the U.S. Pat. No. 4,782,521 discusses a time management system where the user inputs a to-do reminder along with a date and time where the system will display the reminder.

One problem/pitfall associated with prior art PIM systems described above is the inability of such systems to automatically retrieve data from a database using an external trigger as opposed to an internal trigger. For example, when a primary user receives a call/message, it is sometimes necessary for the user to access, immediately, all the information relating to the caller/sender to efficiently handle the communication. In some cases, the primary user needs to be reminded of issues to be addressed, schedules to be reminded of or any relevant data in relation to the caller/sender. Therefore, what is needed is a communication triggered automatic retrieval of information related to a caller/sender.

### SUMMARY OF THE INVENTION

The present invention describes a system and method for providing a primary user with information related to a source (transmitter) of a call/message based on entries stored in a personal information management (PIM) database. In the preferred embodiment, this information is provided upon the receipt of a communication and data available on the originator/transmitter of the call/message is displayed to the primary user. The system of the present invention identifies the caller/sender using an agent associated with the specific communication device/means, receiving the call/message, and retrieves associated entries in a database using the present invention's just-in-time-retrieval system that performs the task of locating and gathering information related to the caller/sender. This information is then summarized and organized for display to the recipient on devices accessible by the user.

In another embodiment, the information is provided at the direct request of the primary user who supplies the system with a client identifier used to locate and gather related entries and records stored in a database. The gathered information is then summarized and organized for display on a user accessible device.

In yet another embodiment, the present invention is implemented in a business model wherein one or more analysts and one or more traders implement the system of the present invention in one or more electronic devices associated with them. In this model, one or more electronic devices receive an incoming communication from a callee and the system of the present invention identifies the callee, gathers information regarding identified callee, and renders the gathered information to one or more analysts and one or more traders via one or more electronic devices.

### BRIEF DESCRIPTION OF THE DRAWINGS

FIG. 1 illustrates an overview of the system architecture of the present invention.

FIG. 2 illustrates the system architecture of a preferred embodiment of the present invention.

FIG. 3 illustrates a flowchart outlining a method for triggering information retrieval, as per the present invention.

FIG. 4 extends the flowchart of FIG. 3 to the preferred embodiment of the present invention.

FIG. 5 illustrates a flowchart outlining the method for the retrieving information from a database.

FIG. 6 illustrates a flowchart outlining the method of the gatherer using the preferred embodiment.

FIG. 7 illustrates a display example of the retrieved information.

FIG. 8 illustrates the many to one example, wherein one or more officials from a company are able to simultaneously communicate with an analyst.

FIG. 9 illustrates the many to many example, wherein one or more officials from a company are able to simultaneously communicate with one or more analyst/traders.

FIG. 10 illustrates the one to many example, wherein one company is able to communicate simultaneously with one or more clients.

FIG. 11 illustrates a scenario wherein one or more participants implementing the system communicate with each other using a common conference call number.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Internet Calendaring and Scheduling Core Object specification (iCalendar) is one of the calendar standards for defining the format of calendar objects (e.g., components, properties), wherein a component is an event using the iCalendar standard for extracting the various organized calendar objects. In one embodiment, the system of the present invention utilizes three iCalendar components: events, to-do and journal. It should, however, be noted that although iCalendar standards and iCalendar components have been used to illustrate the functionality of the present invention, one skilled in the art can extend this concept to encompass other calendaring standards and components.

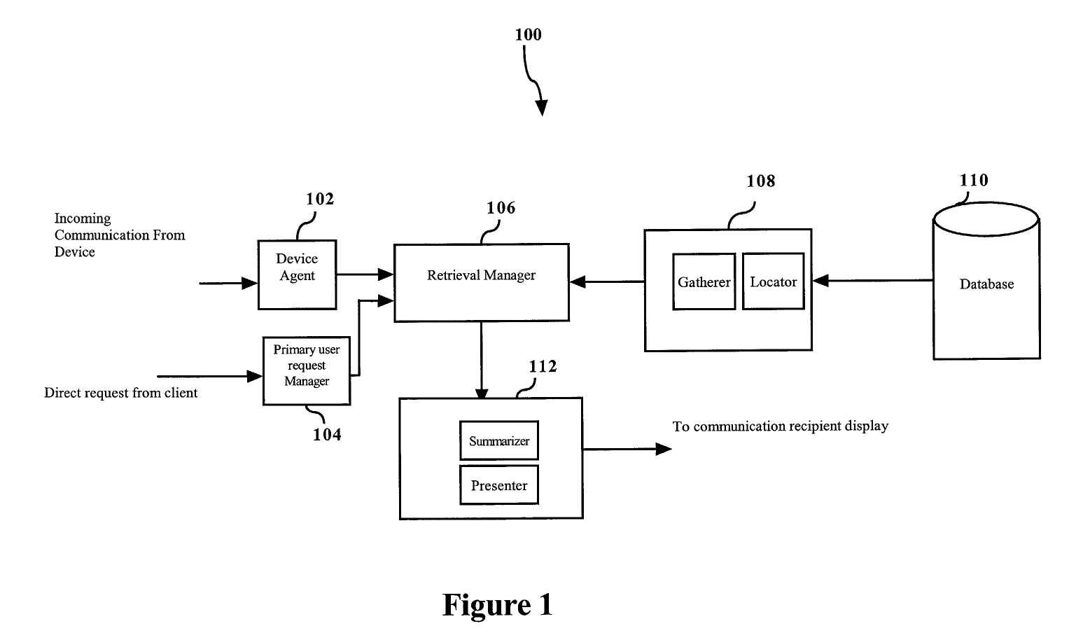

FIG. 1 illustrates an overview of the system architecture 100 of the present invention. System architecture 100 includes: device agent 102 that identifies the sender/caller of the communication and triggers a request to retrieve information; primary user request manager 104 that handles direct requests from a primary user, retrieval manager 106 that controls the retrieval and presentation of the data; data gatherer and locator 108 that finds the data associated with a caller/sender; database 110 that contains relevant data, and lastly, summarizer and presenter 112 that displays the data in an organized way to the primary user of the system.

The system starts with device agent 102 detecting an incoming call/message from an external communication device/means and identifying the sender/caller. Alternatively, the system may be triggered by a direct request from the primary user through a primary user request manager 104. Agent 102 or primary user request manager 104 initiates a request for data retrieval from retrieval manager 106. It should be noted that in the preferred embodiment, the request is sent via any of, but not limited to, the following ways: sockets, messaging (e.g., JMQ), remote method invocation (e.g., RMI, RPC).

Once triggered, the retrieval manager 106 invokes the gatherer and locator system 108 to locate information about the caller/sender. Data gatherer and locator system 108 then queries database 110 for information using the specific identifiers of the caller/sender and the primary user.

Once the requested data is returned by gatherer and locator system 108, retrieval manager 106 then calls the summarizer and presenter system 112 to display the data to the receiver/user depending on their preferences.

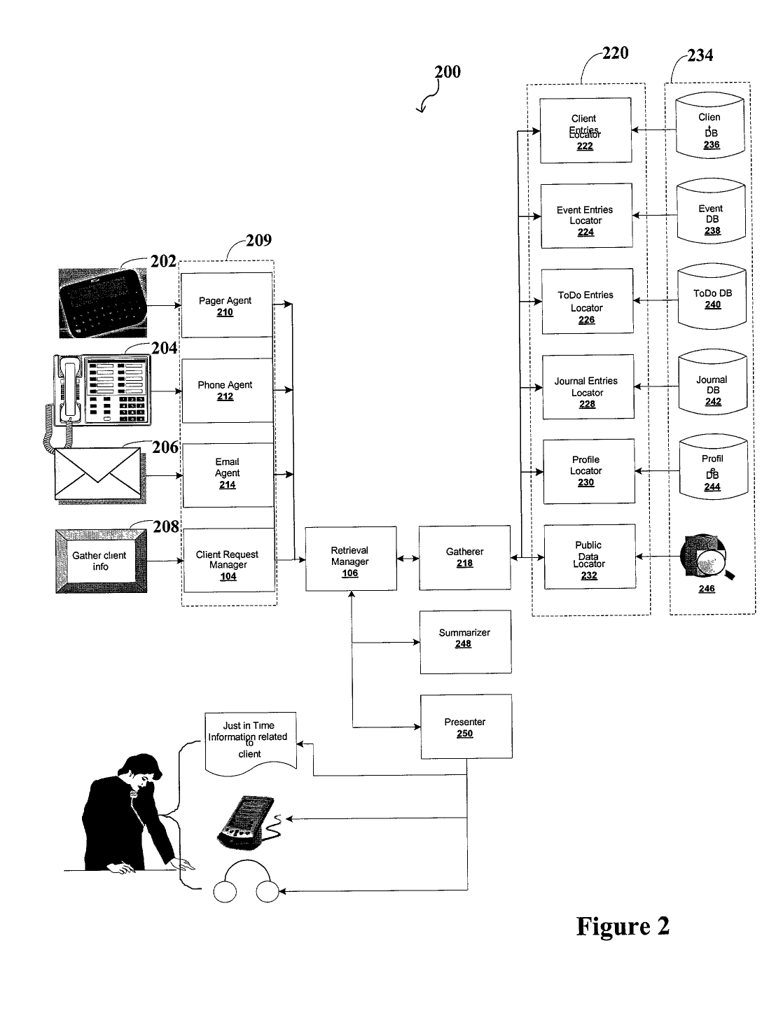

FIG. 2 illustrates a preferred system architecture 200 of this invention where the communication devices/means are any of, but not limited to, the following: pager 202, phone 204 or email 206. Associated with each device/means is an agent that is pager agent 210 for the pager 202, phone agent 212 for phone 204, and email agent 214 for the email 206. Device/means agents 209 monitor their associated device/means for incoming communications. In case of an incoming pager message, pager agent 202 runs as a background task on the recipient's pager watching for incoming paging requests. When an incoming page arrives, pager agent 210 extracts the sender's identifier from pager 202 and then sends a request containing the identifier sender and the primary user to retrieval manager 106. As mentioned earlier, the request is sent via any of, but not limited to, the following ways: sockets, messaging (e.g., JMQ), remote method invocation (e.g., RMI, RPC).

In the case of an incoming phone call, phone agent 212 runs as a background task on the recipient's phone watching for incoming phone calls. When an incoming call arrives, phone agent 212 extracts the caller's identifier using the caller ID feature. Caller ID is a telephone service that allows Customer Premises Equipment (CPE) to receive calling party's directory number and the date/time of the call. Phone agent 212 creates a request, containing the phone numbers of the calling party and the recipient to retrieval manager 106.

In case of an incoming email message 206, email agent 214 runs as a background task on the recipient's machine watching for incoming mail. When an incoming mail arrives for the recipient, the email agent extracts the sender's email address and creates a request containing the email addresses of the sender and the primary user to retrieval manager 106.

A request for data retrieval 208 is directly received from the user through primary user request manager 104. The primary user provides the identifier of a client (on which information is needed) to primary user request manager 104 that sends a request for data to the retrieval manager 106. Once a request is received from one of device agents 209, retrieval manager 106 invokes gatherer 218 to locate information about the designated client, in particular in relation to the primary user.

Gatherer 218 then calls locators 220 to find the information related to a caller/sender and receiver pair in the PIM database 234. In one embodiment, the PIM database contains one or more of, but not limited to, the following databases: client database 236, event entries database 238, to-do entries database 240, journal entries database 242, and profile database 244. In the preferred embodiment, the “event”, “to-do”, and “journal” entries in the respective databases are a group of properties and components as defined in the previously described iCalendar standard. Associated with each of these databases are locators 220 that provide gatherer 218 with the information found in a particular database.

For each database, locators 220 find the information using a set of input parameters that depend on type of incoming communication. In the preferred embodiment of this invention, the input parameters to the various information locators in the system are given below:

Inputs to client entries locator 222 are the client identifier, email address, and phone number.

Inputs to event entries locator 224 are the client identifier, primary user identifier, and the date/time window between which the events occurred/are scheduled to occur.

Inputs to to-do entries locator 226 are the client identifier, primary user identifier, and date/time window between which the to dos are recorded and/or due.

Inputs to journal entries locator 228: client identifier, primary user identifier and date/time window between which entries occurred.

Inputs to profile entries locator 230 and public data 232 locators are client identifiers.

In one embodiment, databases 234 are relational databases, and the information is retrieved using an SQL query. For example, client entries locator 222 queries client database 236 for information concerning a client, given his email address, using a SQL query such as SELECT*FROM CLIENTTBL WHERE EMAILADDRESS=‘client@address.com’. In yet another embodiment, profile database 244 is a simple file system where the information is located using a simple read operation to a file on a disk.

Once the information is found and returned, gatherer 218 passes the information to retrieval manager 106 that calls summarizer 248 to organize the data before its presentation to the primary user.

In one embodiment, summarizer 248 sorts the data using date/time order-future followed by present and past, or vice versa. In another embodiment, summarizer 248 organizes the data based on a priority order. In yet another embodiment, a priority as well as date/time order is applied to data, wherein higher priority data is itemized first as long as they are current or future items.

Finally, presenter 250 takes the output from the summarizer and presents it to the primary user. The presentation medium/device is any of, but not limited to, the following: a graphical user interface (e.g., pop-up window or a refreshed web page), a computer-based device, audio device, PIM device, a pager, a telephone, or a wireless phone.

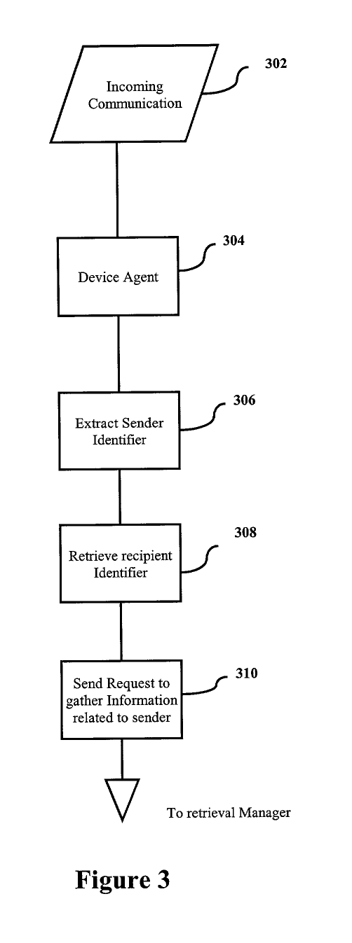

FIG. 3 illustrates the steps, by means of a flow chart, of the present method of this invention for triggering the retrieval of the data. First, an external communication, such as a call or an electronic message, is received 302 by a device agent associated with a particular communication means 304. Next, the device agent extracts the primary user's identifier 306 from the communication devices/means and retrieves the recipient's identifier 308 before sending a request to gather information from databases 310 regarding the initiator of the external communication.

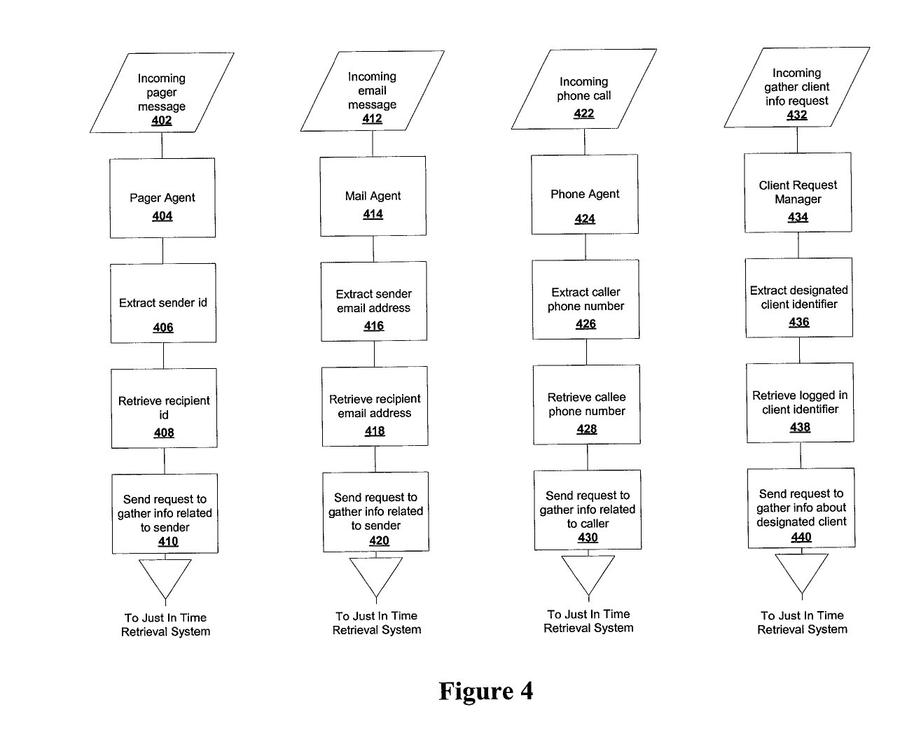

FIG. 4 illustrates, in further detail, the steps described in FIG. 3 using the communication devices/means of the preferred embodiment. The figure shows the steps outlined in FIG. 3 for different communication means and their associated agents.

In the case of an incoming page message 402, a pager agent detects 404 the page and initiates the extraction 406 of the sender identifier. Then, the pager agent retrieves the recipient identifier 408 before requesting information 410 related to the sender to the retrieval manager along with the sender and the recipient identifiers.

In the case of an incoming email message 412, a mail agent detects 414 the email and extracts 416 the sender's email address. Then, the email agent retrieves 418 the recipient's email and sends a request 420 to gather information related to the sender along with the sender and recipient identifiers.

In the case of an incoming phone call 422, a phone agent detects 424 the call and extracts 426 the caller phone number. Then, the phone agent retrieves 428 the recipient's phone number before sending a request 430 to find information related to caller along with the caller and called party numbers.

In the case of a direct request by the primary user 432, primary user request manager detects the user input 434 and extracts the client identifier 436 as well as the primary user's identifier 438. Then the primary user request manager sends a request for information to the retrieval manager along with the two identifiers 440.

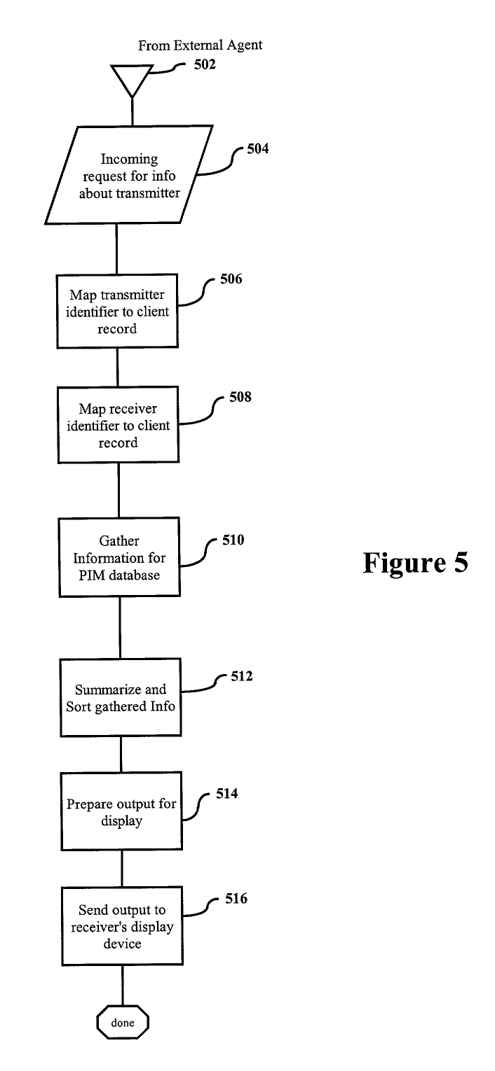

FIG. 5 illustrates the steps, by means of a flow chart, of the present method of this invention for retrieving and presenting the data to the recipient. The retrieval system gets a request from an external agent for information by providing two identifiers one corresponding to a client identifier and the other to the principal user of the system 504. The system maps transmitter identifier 506 and receiver identifier 508 to stored records in the database. Then, gatherer 510 groups located information. The gathered information is condensed by the summarizer 512 and then prepared for display by the presenter 514 before sending it for display to the specific device 516.

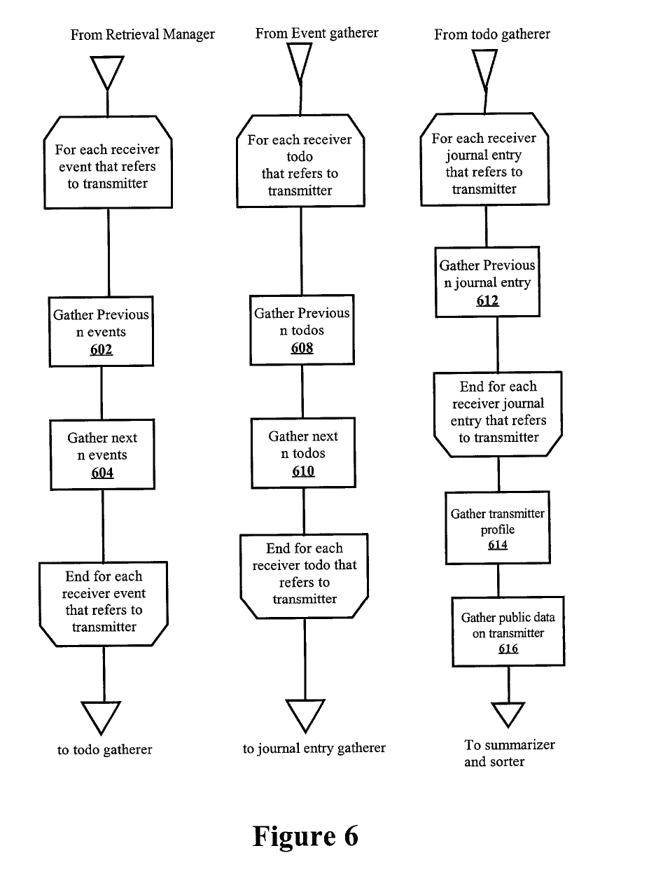

FIG. 6 further illustrates the gathering step 510 outlined in FIG. 5 in more detail. The method describes how and what information is gathered from the PIM database in the preferred embodiment of this invention. The gatherer calls the various locators to obtain information about a client related to the primary user of the system. First, the gatherer instructs the event entries locator to find past and future event entries related to a client by providing two identifiers, one for the client and the other for the primary user of the system. The gatherer collects a predetermined number of previous events 602 and future events 604 relative to the current date. Next, the gatherer initiates the to-do entries locator to find past and future to-do entries related to the client by providing two identifiers one for the client and the other for the primary user of the system. The gatherer collects a predetermined number of previous to-do entries 606 and future to-do entries 608 relative to the current date. Lastly, the gatherer initiates the journal entries locator to find journal entries related to a client by providing two identifiers, one for the client and one for the primary user of the system. The gatherer assembles a predetermined number of previous journal entries relative 612 to the current date. Then, the gatherer collects the client profile located by the profile locator 614 and all public data (via the Internet) available on the client 616 before sending all the gathered information on the client to the summarizer and sorter.

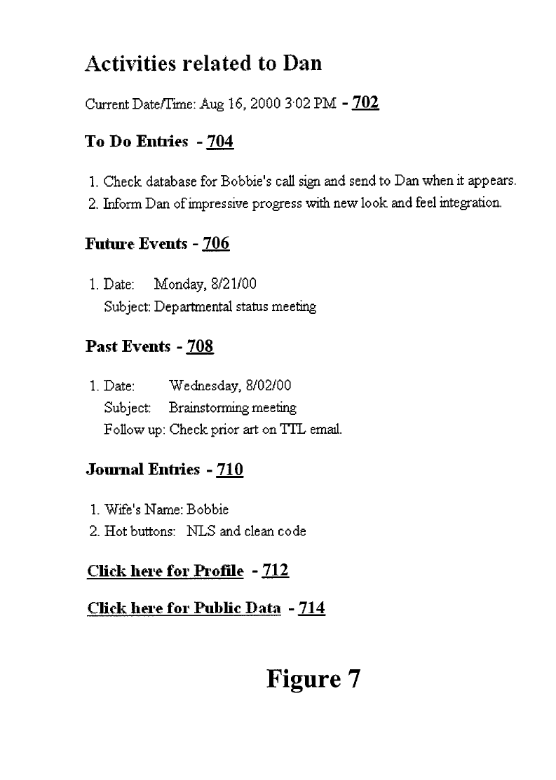

FIG. 7 illustrates an example of the information displayed to the primary user of the preferred embodiment. The data retrieved from the database include to-do entries, future and past event entries, journal entries, profile information available in the PIM database, and public data related to a person (Dan). First, the current date is displayed in 702 and then, future to-do entries 704 and future events 706 are also displayed. Next, a list of past events 708 is displayed. Additionally, a list of journal entries 710 related to the client is also displayed. Lastly, a profile of the client 712 and public data 714 regarding the client is provided, as hyperlinks that are accessed if needed.

Unlike the prior art methods, the data shown in 700 is displayed automatically upon the receipt of a triggering external communication and does not require an internal trigger.

### EXAMPLES

1a. Many to One (Caller to Callee) Example

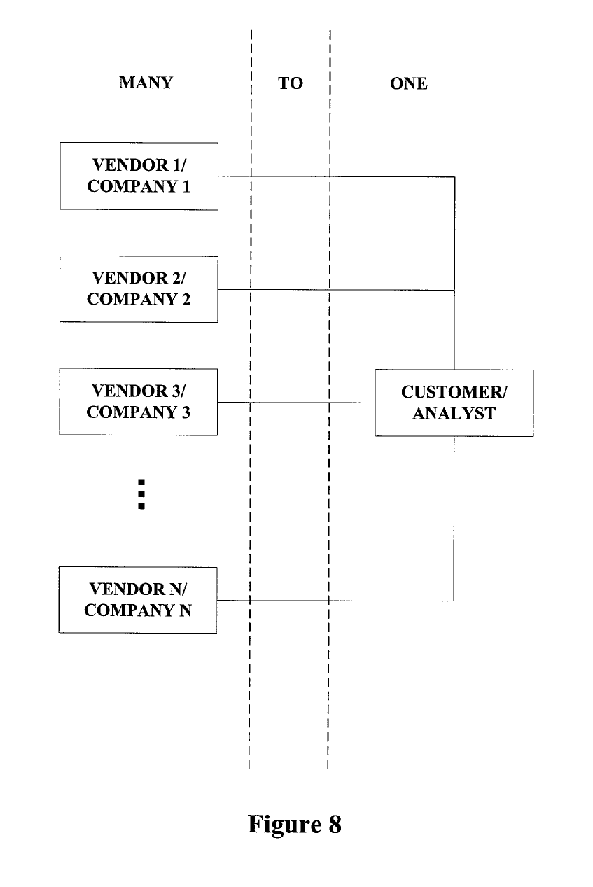

In this embodiment, the system of the present invention works on behalf of an agent identified as the customer agent. FIG. 8 illustrates a many-to-one example wherein one or more vendors/companies have access, and are able to simultaneously communicate with, a customer agent implementing the system of the present invention to perform a business transaction such as buying or selling financial securities (e.g., such as stocks, bonds, liquidities, equities, financial instruments, buying or selling goods, buying or selling services, buying, selling, or leasing real property, etc.). It should be noted that, although specific examples of business transactions are provided in the specification, they are not intended to limit the scope of the present invention. In this scenario, first, a phone call is detected from a vendor agent to the customer agent. The system then recognizes the identity of the vendor and calls up any outstanding previously placed orders with the identified vendor. Next, the system queries a database to help identify suppliers of the vendor agent. In alternative embodiments, the system uses a data-mining agent such as a Web crawler to identify suppliers associated with the vendor agent. As a next step, the system access websites associated with all of the identified suppliers and determines if a key supplier has reported delivery problems.

In a specific example, the vendor is Ford and the supplier is Firestone. Furthermore, in this example, Ford only purchases tires from Firestone and all of these tires have been recalled, the present system receives a call from vendor (Ford) and information regarding the supplier (Firestone) is mined out of the Web and presented to a customer agent informing it of the recall associated with the supplier's (Firestone's) tires. Lastly, the call is connected and the customer then picks up the phone, proceeds with the conversation with this knowledge in mind. The customer then makes strategic decisions, like canceling the order and placing the order with an alternative vendor, based on this extracted information.

1b. Many to One Second Example

In this example, the system of the present invention works on behalf of an investment analyst to aid in decisions related to business transactions. As a first step, an investment analyst receives a call from a company's communication official and a Vice President (VP) for product development in NewCompany.com. Then, the system of the present invention detects this call and connects to the company's (Newcompany's) website to gather information related to the company. In this specific example, the system gathers a list of all executive officers associated with NewCompany.com. For example, the system finds an article mentioning the chief software designer and Vice President for research at NewCompany has left for competitor FastMover.com. This information (and all other articles found) is dispatched to the investment analyst. As a next step, the analyst receives this information and then picks up the phone to answer the call from the communication official and Vice President for product development in NewCompany.com. The communication official and the Vice President then inform the analyst about new changes in product strategy at NewCompany.com. The analyst is then able to decide whether to buy or sell stock holdings based on the conversation and the information retrieved by the system.

2. Many to Many Example

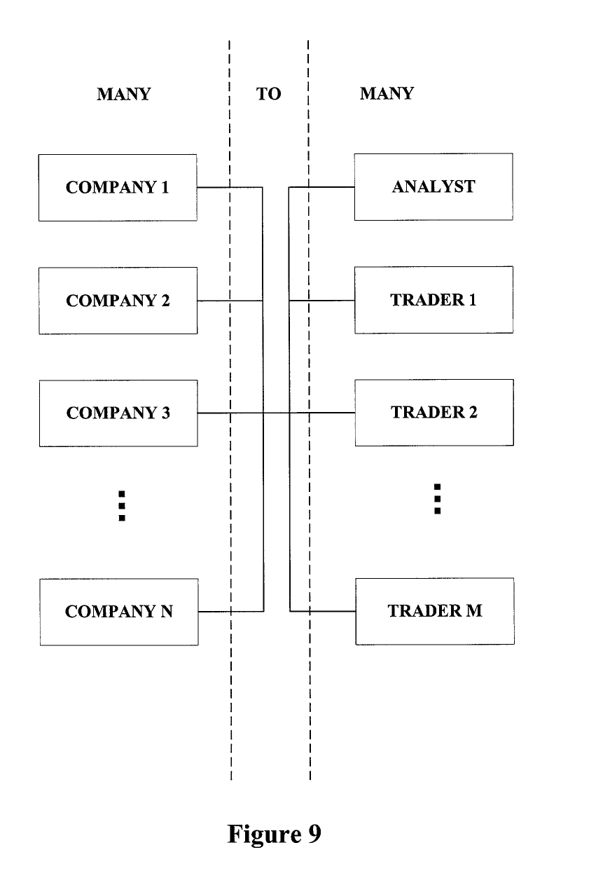

In this example, as illustrated in FIG. 9, one or more companies are able to communicate simultaneously with an investment analyst and one or more traders implementing the system of the present invention to aid in decisions related to business transactions, such as buying or selling financial securities. An investment analyst receives a call from a communications official and the Vice President for product development at NewCompany.com. Next, the system of the present invention detects this call, identifies the callee, and connects to the website associated with the callee to gather information. In this specific example, the system gathers a list of all executive officers of NewCompany.com and searches the Web for information on NewCompany and all of its identified executive officers. For example, the system could identify that the chief software designer and Vice President for research at NewCompany has left for competitor FastMover.com. As a next step, all of the identified information (e.g., all articles found on the Web) is dispatched to the terminal of an investment analyst and to one or more traders at Analysts Company. At this point any of the mentioned one or more traders are able to optionally join in on the call. Lastly, the phone call connection is complete and the investment analyst picks up the phone with all the identified articles displayed in front of him. Thus, the traders and analyst have a conference call with a communications official and VP for product development at NewCompany, and the official informs them of new change in product strategy. The analyst and the traders are then able to decide whether to buy or sell stock holdings based on the conversation and the information retrieved by the system of the present invention. The analyst and the traders could also decide that, based on the retrieved information, it is in their best interest to buy stocks at FastMover.com since the VP moved from NewCompany.com to FastMover.com.

3. One to Many Example

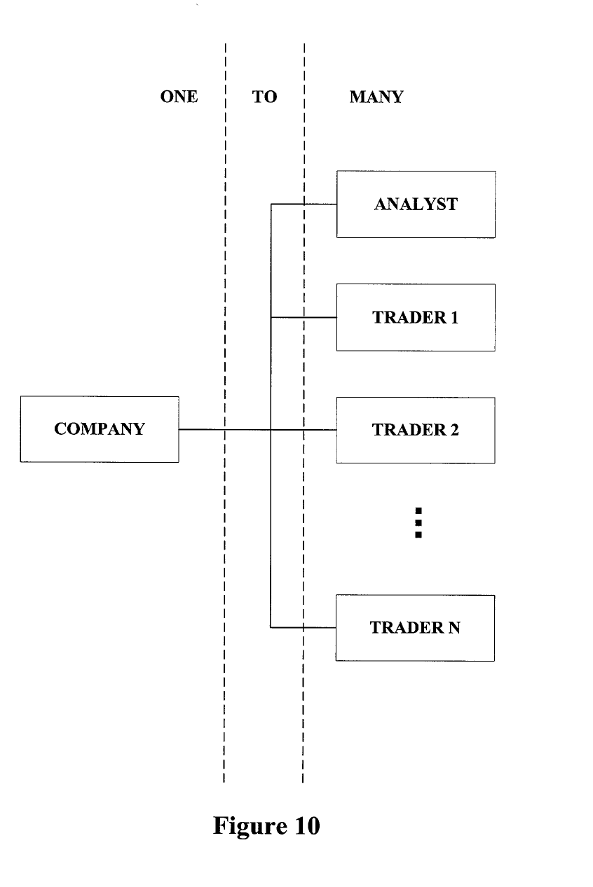

In this example, as illustrated in FIG. 10, a company is able to communicate simultaneously with an investment analyst and one or more traders implementing the system of the present invention, wherein the system aids the analyst and traders to perform financial transactions. One or more investment analysts receive a call from a communications official at a company such as IBM. Then, the system of the present invention detects the call in each instance and connects to IBM's website and extracts company news from the website. In a specific example, the system might extract information regarding a specific product, say product A. Next, any extracted information regarding product A is dispatched to the terminal of the investment analyst and one or more traders at Analysts Company. Furthermore, the traders are also given the option of joining in the call. The phone call connection is then complete and the investment analyst picks up the phone. The traders and analysts have a conference call with the communications official at IBM, who informs them about an exciting new product just announced (product A). The investment analyst then uses the extracted information, along with the information provided by the communications official, in his decision during purchasing of IBM stock.

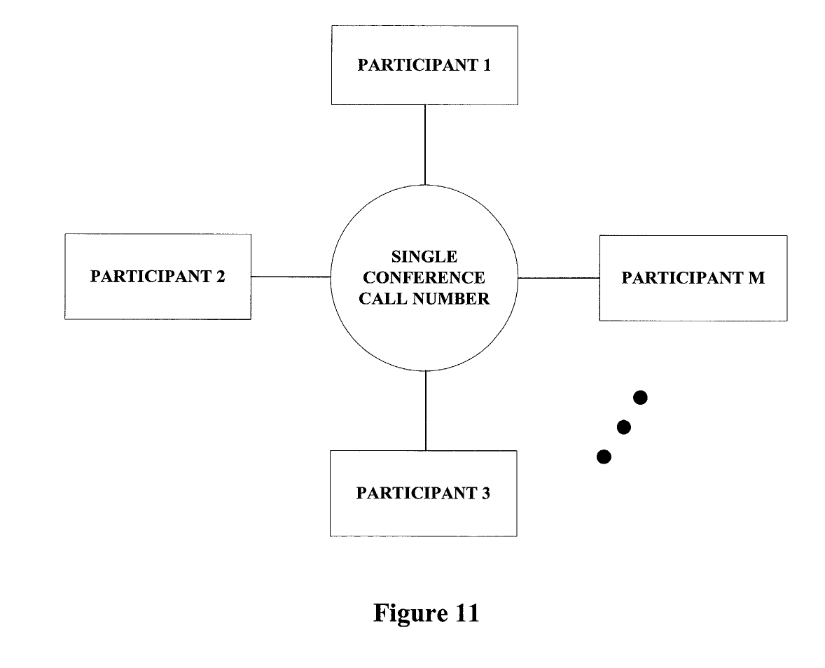

It should be noted that, in an extended embodiment, the participants in the many-to-one, many-to-many and one-to-many scenarios are able to simultaneously communicate with each other by calling into a common single conference as shown in FIG. 11.

### Conclusion

A system and method has been shown in the above embodiments for the effective implementation of communication triggered just in time information. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by software/program, computing environment, specific computing hardware, and specific calendaring or PIM systems.

The above enhancements for personal information management systems and its described functional elements are implemented in various computing environments. For example, the present invention may be implemented on a conventional IBM PC or equivalent, multi-nodal system (e.g., LAN), or networking system (e.g., Internet, WWW, wireless web). All programming, GUIs, and data related thereto are stored in computer memory, static or dynamic, and may be retrieved by the user in any of: conventional computer storage, display (i.e., CRT), and/or hardcopy (i.e. printed) formats. The programming of the present invention may be implemented by one of skill in the art of personal information management systems.

1. A method for automatically retrieving and rendering information regarding a source of an incoming communication, said method comprising a plurality of steps, one or more of said steps implemented locally or remotely, said method comprising:
a. receiving said incoming communication from said source intended for one or more recipients;
b. detecting identity of said source;
c. extracting data regarding said detected source, said data comprising any of, or a combination of, the following information: to-do entries, future and past event entries, journal entries, and profile information;
d. summarizing said extracted data;
e. notifying said one or more recipients of said incoming communication, and
f. rendering said data in one or more electronic devices associated with said one or more recipients of said incoming communication.

2. A method for automatically retrieving and rendering information regarding a source of an incoming communication, as per claim 1, wherein said combination comprises the following information: to-do entries, future and past event entries.

3. A method for automatically retrieving and rendering information regarding a source of an incoming communication, as per claim 1, wherein said incoming communication is sent via any of the following: sockets, Java messaging queue (JMQ), remote procedure call (RPC), or remote method invocation (RMI).

4. A method for automatically retrieving and rendering information regarding a source of an incoming communication, as per claim 1, wherein said step of extracting data is performed over one or more networks.

5. A method for automatically retrieving and rendering information regarding a source of an incoming communication, as per claim 1, wherein said extracted data is in iCalendar format.

6. A method for automatically retrieving and rendering information regarding a source of an incoming communication, as per claim 5, wherein said method further comprises chronologically ordering said extracted data in iCalendar format.

7. A method for automatically retrieving and rendering information regarding a source of an incoming communication, as per claim 1, wherein said data is extracted from any of the following databases: an event database containing one or more recorded events, a to-do database containing one or more actions to be performed, a journal database containing one or more journal entries, or a profile database containing one or more profiles associated with one or more clients.

8. A method for automatically retrieving and rendering information regarding a source of an incoming communication, as per claim 1, wherein said step of extracting data further comprises extracting additional data related to said detected source from the World Wide Web (WWW).

9. A method for automatically retrieving and rendering information regarding a source of an incoming communication, as per claim 8, wherein said extracted additional data includes said profile data.

10. An article of manufacture comprising a computer usable medium having computer readable program code embodied therein which automatically retrieves and renders information regarding a source of an incoming communication, said article comprising:
computer readable program code receiving said incoming communication from said source intended for one or more recipients;
computer readable program code detecting identity of said source;
computer readable program code extracting data regarding said detected source, said data comprising any of, or a combination of, the following information: to-do entries, future and past event entries, journal entries, and profile information;
computer readable program code summarizing said extracted data;
computer readable program code notifying said one or more recipients of said incoming communication, and
computer readable program code rendering said data in one or more electronic devices associated with said one or more recipients of said incoming communication.

11. An article of manufacture comprising a computer usable medium having computer readable program code embodied therein which automatically retrieves and renders information regarding a source of an incoming communication, as per claim 10, wherein said data is extracted from any of the following databases: an event database containing one or more recorded events, a to-do database containing one or more actions to be performed, a journal database containing one or more journal entries, or a profile database containing one or more profiles associated with one or more clients.

12. An article of manufacture comprising a computer usable medium having computer readable program code embodied therein, which automatically retrieves and renders information regarding a source of an incoming communication, as per claim 10, wherein said article further comprises computer readable program code extracting additional data related to said detected source from the World Wide Web (WWW).

13. An article of manufacture comprising a computer usable medium having computer readable program code embodied therein, which automatically retrieves and renders information regarding a source of an incoming communication, as per claim 12, wherein said extracted additional data includes said profile data.

14. A system for automatic retrieval and rendering of information related to one or more sources, said system comprising:
one or more databases storing information related to one or more sources, said databases accessible over one or more networks;
one or more device agents detecting one or more requests for communication from said sources, said device agents further extracting identity of said sources;
a retrieval manager operatively linked to said agents initiating retrieval of data, regarding said identified sources, from said databases, and
a presenter operatively linked to said retrieval manager rendering said retrieved data in one or more electronic devices.

15. A system for automatic retrieval and rendering of information related to one or more sources, as per claim 14, wherein said retrieved data is in iCalendar format.

16. A system for automatic retrieval and rendering of information related to one or more sources, as per claim 15, wherein said system further comprises a summarizer chronologically organizing said retrieved data in iCalendar format.

17. A system for automatic retrieval and rendering of information related to one or more sources, as per claim 14, wherein at least one of said one or more databases is a relational database that is accessible via search query language (SQL).

18. A system for automatic retrieval and rendering of information related to one or more sources, as per claim 14, wherein said requests for communication are any of the following: a pager message, an e-mail message, or a telephone call.

19. A system for automatic retrieval and rendering of information related to one or more sources, as per claim 14, wherein said one or more databases is any of the following: an event database containing one or more recorded events, a to-do database containing one or more actions to be per formed, a journal database containing one or more journal entries, or a profile database containing one or more profiles associated with one or more clients.

20. A system for automatic retrieval and rendering of information related to one or more sources, as per claim 14, wherein said electronic devices are any of the following:
telephones, mobile telephones, WAP-enabled telephones, pagers, personal digital assistants (PDAs), electronic tablets, personal computers (PCs), mobile computers, laptops, or wireless computer-based devices.

21. A system for automatic retrieval and rendering of information related to one or more sources, as per claim 14, wherein said system further comprises:
one or more entries locators associated with said one or more databases identifying specific calendar entries associates with said one or more sources, and
a gatherer collecting and passing said identified specific calendar entries to said retrieval manager.

22. A system for automatic retrieval and rendering of information related to one or more sources, as per claim 14, wherein said networks comprise any of the following: local area network (LAN), wide area network (WAN), wireless network, or Internet.

23. A method for facilitating business transactions, based on information retrieved over the World Wide Web, said method comprising:
receiving a communication from a business;
detecting identity of said business;
accessing the World Wide Web and extracting information related to said detected identity;
summarizing said extracted information, and
performing a business transaction based on said summarized information.

24. A method for facilitating business transactions, based on information retrieved over the World Wide Web, as per claim 23, wherein said communication is a telephonic communication.

25. A method for facilitating business transactions, based on information retrieved over the World Wide Web, as per claim 23, wherein said method further comprises the step of rendering said summarized information in one or more browser enabled electronic devices associated with one or more clients.

26. A method for facilitating business transactions, based on information retrieved over the World Wide Web, as per claim 23, wherein said business transaction are transactions related to financial securities.

27. An article of manufacture comprising a computer usable medium having computer readable program code embodied therein which facilitates business transactions, based on information retrieved over one or more networks, said article comprising:
computer readable program receiving a communication from a business;
computer readable program code detecting identity of said business;
computer readable program code accessing the World Wide Web and extracting information related to said detected identity;
computer readable program code summarizing said extracted information, and
computer readable program code performing a business transaction based on said summarized information.
